(19) United States
(12) Patent Application Publication
(10) Pub. No.: US 2026/0152825 A1
(43) Pub. Date: Jun. 4, 2026

(54) GRAPHENE REINFORCED ALUMINUM METAL MATRIX COMPOSITES FOR HIGH CONDUCTIVITY APPLICATIONS AND PROCESS FOR PRODUCING

(71) Applicant: Martinrea International US Inc., Auburn Hills, MI (US)

(72) Inventors: Srinath Kistampally, Citrus Heights, CA (US); Pat Walsh, Macomb, MI (US)

(21) Appl. No.: 18/953,440

(22) Filed: Nov. 20, 2024

Related U.S. Application Data
(60) Provisional application No. 63/602,065, filed on Nov. 22, 2023.

(51) Int. Cl. C22C 1/05; B23K 11/11; H01M 50/522

(52) U.S. Cl. CPC C22C 1/05; B23K 11/11; H01M 50/522

(57) ABSTRACT

A process for producing a graphene reinforced aluminum metal matrix composite material, including the steps of providing a flowable aluminum material, combining multiple flattened sheets of graphene or a graphene powder with the aluminum material, and processing the combination to create the aluminum metal matrix composite material incorporating the graphene and orienting the graphene to enhance conductivity. A current carrying article providing high conductive properties is also disclosed and includes an aluminum metal matrix composite combined with an oriented graphene in order to achieve enhanced electrical conductivity.

### CROSS REFERENCE TO RELATED APPLICATIONS

The present application claims the priority of U.S. Ser. No. 63/602,065 filed Nov. 22, 2023.

### FIELD OF THE INVENTION

The present invention relates generally to improvements in electrically conducting materials, such as including without limitation bus bar or other electrical current carrying component technology. More specifically, the present invention teaches an aluminum metal matrix composite material (Al MMC) reinforced with graphene provided as a lower cost alternative to conventional copper in order to provide a combination of reduced weight and price savings, along with providing higher recyclability.

### BACKGROUND OF THE INVENTION

The rapidly accelerating shift from internal combustion (IC) to electric (EV) vehicles has contributed to a reimagining of vehicle architectures. Original equipment manufacturers, also termed OEMs, have realized that this architectural break represents opportunities to optimize components throughout a vehicle down to the fundamental building blocks of the electrical architecture. In this regard, OEMs have been exploring use of flat conductors called busbars for carrying more electrical power than traditional cables while maximizing the use of space within the vehicle, while enabling greater automation in vehicle assembly in order to reduce costs and increase safety.

Busbars are solid metal bars, typically flat and rigid which are used to carry current. Traditionally made from copper or aluminum based alloys, busbars are wider than cables but shorter in height. They can also carry more current than cables with the same cross-sectional area. These attributes make busbars ideal for some high-voltage connections in electric vehicles and a key component of the electrical architecture.

As is also known, the choice between aluminum and copper bus bars in electric vehicles (EVs) involves a trade-off between various factors, including electrical conductivity, weight, cost, and thermal performance. Each material has its advantages and disadvantages, and the decision often depends on specific design requirements and priorities. In electric vehicles (EVs), such as the Tesla Model 3, traditional copper busbars have been replaced with aluminum busbars (e.g., Al 6101 grade).

The conductivity of pure aluminum is approximately 65.0% of IACS (International Annealed Copper Standard). However, aluminum can be as much as 70% lighter than copper. Accordingly, an electrically conducting accessory, such as including without limitation an Aluminum based Busbar System, can weigh significantly less than a copper system of equal conductance while providing the level of electrical conductivity required for a given application.

As is further known, the electrical conductivity of metals is a result of the movement of electrically charged particles, with the atoms of metal elements are characterized by the presence of valence electrons, which are electrons in the outer shell of an atom that are free to move about. It is these “free electrons” that allow metals to conduct an electric current.

Further, and because valence electrons are free to move, they can travel through the lattice that forms the physical structure of a metal. Under an electric field, free electrons move through the metal much like billiard balls knocking against each other, passing an electric charge as they move. The transfer of energy is strongest when there is little resistance. Again analogizing, on a billiard table this occurs when a ball strikes against another single ball, passing most of its energy onto the next ball. If a single ball strikes multiple other balls, each of those will carry only a fraction of the energy.

By the same token, the most effective conductors of electricity are metals that have a single valence electron that is free to move and causes a strong repelling reaction in other electrons. This is the case in the most conductive metals, such as silver, gold, and copper. Each has a single valence electron that moves with little resistance and causes a strong repelling reaction.

Conduction in metals must follow Ohm's Law, which states that the current is directly proportional to the electric field applied to the metal. Resistivity is the opposite of the electrical conductivity of metals, evaluating how strongly a metal opposes the flow of electric current, which is commonly measured across the opposite faces of a one-meter cube of material and described as an ohm meter (Ω·m), with resistivity is often represented by the Greek letter rho (ρ). Electrical conductivity, on the other hand, is commonly measured by siemens per meter (S·m⁻¹) and represented by the Greek letter sigma (σ). One siemens is equal to the reciprocal of one ohm.

An example of an aluminum metal matrix busbar is depicted in US 2023/0307154 to Boehm which incorporates nanoscale carbon particles or carbon nanotubes.

As is further known, the main differences between graphene and carbon nanotubes include the structure of graphene being provided as a single layer 2D film, whereas carbon nanotubes are provided as thin films rolled into a three dimensional tubular/cylindrical shape. As is further known, the angle and diameter at which carbon nanotubes are rolled affects its properties.

### SUMMARY OF THE INVENTION

The present invention discloses an aluminum-based alloy, such as in particular a graphene reinforced aluminum metal matrix composite, which provides similar electrical conductivity as copper at reduced weight and cost. The present invention additionally discloses an associated thermal processing, such as sintering, casting, melting thixocasting, semi-solid forming or like process for producing the aluminum metal matrix material (Al MMC) with a few layer graphene (this further defined as one or more layers of flattened graphene sheets).

A suitable deformation process, such as without limitation including extruding, rolling, forging, or other bulk-forming process, orients the dispersed graphene in order to approximate the higher conductivity properties of a single layer graphene. Without limitation, the thermal processed Al MMC material aligns the flattened graphene layers (without limitation further including two to five layers however operable for up to ten layers of graphene) in order to enhance conductivity of the material.

A corresponding process for producing the graphene reinforced aluminum metal matrix composite material includes the steps of providing a flowable aluminum material, such as without limitation an aluminum powder, molten or semi-molten aluminum combining the flattened graphene sheets with the aluminum material, thermally processing the combination to create the aluminum metal matrix composite material incorporating the graphene, and orienting the graphene into a single layer to enhance conductivity.

The step of thermally processing the combination to create the aluminum metal matrix material further includes a thermal process, with the step of blending the combination of aluminum powder and flattened graphene sheets providing for even distribution, along with the provision of a subsequent deformation process such as without limitation extrusion or rolling process for orienting the graphene particles in a preferred direction within the matrix of aluminum in order to enhance conductivity, and which may also transform a few layer graphene (FLG), e.g. typically again 2-5 layers, into a single layer graphene (SLG).

The present invention also discloses any current carrying article such as without limitation a busbar, providing enhanced conductive properties, and including an aluminum metal matrix composite combined with an oriented graphene in order to achieve enhanced electrical conductivity. The present invention also discloses other applications for the highly conductive Al MMC composite material not limited to those described and illustrated herein.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 illustrates a thermal processing not limited to any of sintering, casting, melting, thixocasting, semi-solid forming, etc. for creating the aluminum metal matrix composite incorporating graphene for high conductivity applications;

FIG. 2 depicts a collection of single layer graphene, few or multi-layer graphene, few or multi-layer graphene with graphene nano-platelets, and graphite powders incorporated into the aluminum metal matrix composite material;

FIG. 3 is a schematic illustration of a non-limiting thermal or deformation process not limited to any of extruding, rolling, forging or other bulk-forming process for post forming the AL MMC material with few or multi-layer graphene or graphene powder into a finished material with a single oriented graphene layer exhibiting higher conductivity;

FIG. 4 presents a micrograph of graphene dispersed in aluminum prior to the deformation process; and

FIG. 5 presents a succeeding view to FIG. 4 and showing a further micrograph of the graphene in aluminum following the deformation process and depicting an elongated network of the graphene configured along the grain boundaries to provide enhanced electrical conductivity.

### DETAILED DESCRIPTION OF THE PREFERRED EMBODIMENTS

With reference to the attached illustrations, the present invention discloses a current carrying component in the form of an aluminum metal matrix composite incorporating graphene as a lower cost alternative to conventional copper in order to provide a combination of weight and price savings, along with high recyclability. As previously noted, the Aluminum MMC material is reinforced with one or more layers of flattened graphene sheets or films (this further defined as few layer graphene including a range of layers up to ten but typically two to five layers) which are subsequently oriented in order to provide enhanced electrical conductivity as a cost effective and lightweight alternative to traditional copper materials, such as incorporated into EV vehicle bus bar and other applications.

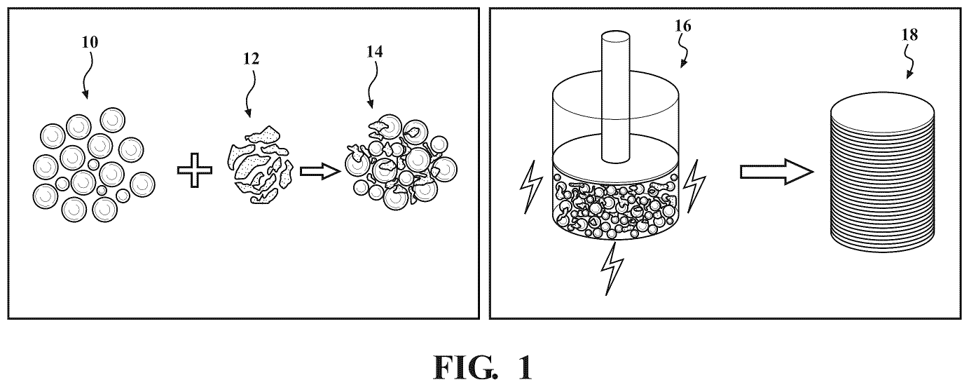

Referring initially to FIG. 1, illustrated is a non-limited thermal process for creating an aluminum metal matrix composite incorporating any number of graphene sheets, such as which is again converted from two to five layers into a single layer, for high conductivity applications. Such thermal forming processes can include, without limitation, sintering or frottage for forming a solid mass of material by pressure or heat. As will be further described, other thermal processes such as casting, melting, thixocasting semi-solid forming and the like can be substituted for the sintering process.

A volume of flowable aluminum (Al) (such including without limitation AlSi10Mg alloy) is depicted at 10 and is combined with a volume of sheets of graphene 12, such as a few layer graphene material (FLG), in order to create an aluminum graphene blend 14. Although not required, an optional milling or grinding step can be utilized to grind or blend the mixed blend 14 of materials and works on the principle of size reduction accomplished by impact.

In one non-limiting application, this can envision use of a mill grinder with a plurality of balls (typically steel, ceramic or rubber) which partially fill a hollow cylindrical shell rotating about its axis, and which further may be either horizontal or at a small angle to the horizontal. The inner surface of the cylindrical shell can further be lined with an abrasion-resistant material such as manganese steel or rubber lining.

A thermal processing operation is generally represented at 16 for creating the completed article or product 18. As described, this can again include a variety of non-limiting processes encompassing sintering, casting, melting, thixocasting, semi-solid forming and the like.

In one non-limiting example, the processing operation 16 contemplates the combined aluminum and graphene material being combined and placed within a thermal process into a defined shape, with the material partially melted and subsequently thixoformed (defined as semi-solid state casting).

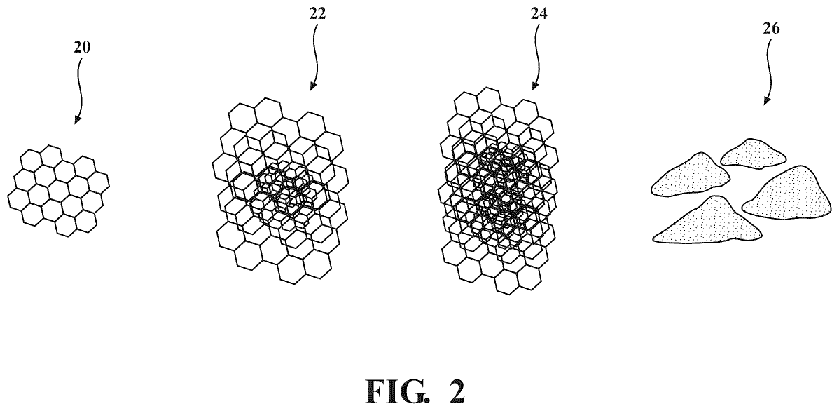

FIG. 2 depicts individual representations of graphene options incorporated into the graphene reinforced aluminum metal matrix composite and including each of a single layer graphene 20, a few or multi-layer graphene, defined as up to ten layers and shown at 22, or few or multi-layer graphene with graphene nano-platelets, which can range up to two hundred and fifty layers and shown at 24. Finally, the present invention also contemplates graphite powder, at 26, incorporated into the aluminum metal matrix composite material.

Advantages of reduced weight aluminum based conductors include cost savings in many areas (reduced shipping costs, less manpower for installation, etc.). When comparing conductivity by weight, aluminum has been found to be fifty percent more conductive per kilogram (kg). The price ratio of copper to aluminum is currently over 3:1. As a result, the completed article costs, such as without limitation an aluminum busbar, can be considerably lower than the cost of a comparative copper busbar, and in which its lightweight properties may provide substantial cost savings along with providing high recyclability, making it much less likely to suffer demand volatility or supply shortages.

Other advantages and Limitations of Aluminum include it being approximately forty percent lighter than copper, making it a preferred material for applications where weight reduction is critical. Additionally, aluminum is more cost-effective compared to copper. The substitute of aluminum busbars for traditional copper requires an approximately fifty percent increase in cross sectional area for maintaining equivalent ampacity (or current carrying capacity). Also, and while aluminum's reduced weight is advantageous, its increased size can tend to limit its usefulness in applications where space is constrained, such as within an EV battery enclosure.

Consistent with the teachings of the present invention, advantages of Aluminum-Graphene (AL-G) Busbars include improved conductivity over aluminum alone (see again as previously discussed in FIG. 2 in relation to the reduced resistivity of aluminum with graphene over aluminum alone). Aluminum-graphene busbars, due to their enhanced conductivity, require a smaller cross-sectional area than standard aluminum busbars (for example: maybe only twenty percent larger than copper cross-sections), while maintaining the same ampacity as copper. This offers a significant advantage by achieving weight reduction, cost savings, and more efficient use of space in tightly packed environments, such as EV battery compartments.

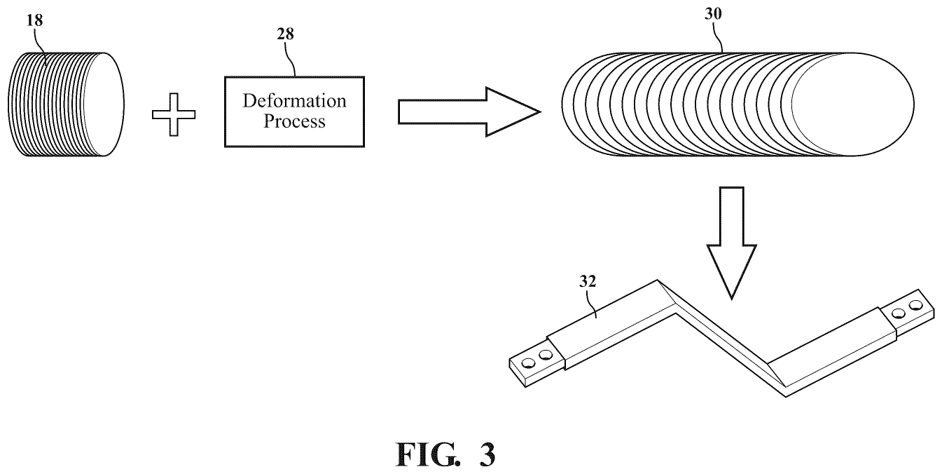

Proceeding to FIG. 3, a schematic illustration is shown of a thermal or deformation process, not limited to any of extruding, rolling, forging or other bulk-forming process, for post forming the AL MMC material with few or multi-layer graphene or graphene powder into a finished material with a single oriented graphene layer exhibiting higher conductivity. The process orientation of the graphene article further is accomplished within the matrix of aluminum in order to enhance the conductivity of the material, which may also transform the few layer graphene FLG to approximate that of a single layer graphene (SLG) utilizing any of an existing sintering, casting, melting thixocasting semi-solid forming or the like.

As generally referenced at 28, the deformation process results in the graphene in the deformed product being oriented along grain boundaries (see further at 30). In this manner, the end composition incorporates the oriented graphene prior again to it being formed into a final article, product or component, depicted in non-limiting representation at 32 in the form of a busbar shaped article 2.

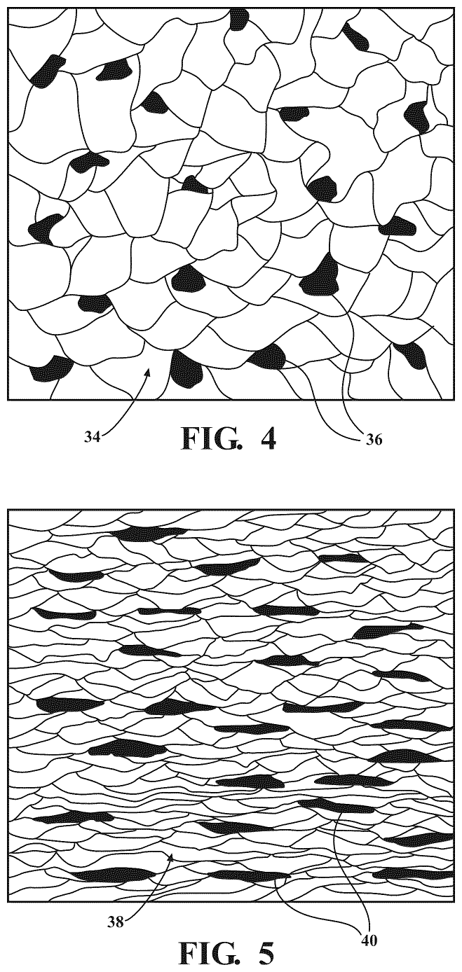

FIG. 4 generally depicts, at 34, a micrograph of graphene, further at 36 dispersed in aluminum prior to the deformation process. As further shown, the graphene dispersion is visible in a non-aligned condition.

Finally, FIG. 5 presents a succeeding micrograph to FIG. 4, and showing a further micrograph, generally at 38, of the graphene in aluminum following the deformation process and depicting an elongated network of the graphene, further at 40, configured along the grain boundaries to provide enhanced electrical conductivity.

A corresponding process for producing a graphene reinforced aluminum metal matrix composite material is also disclosed and includes the steps of providing a flowable and molten aluminum material, combining a plurality of flattened sheets of graphene with the aluminum material, processing the combination to create the aluminum metal matrix composite material incorporating the graphene, and orienting the flattened sheets of graphene to enhance conductivity.

Other steps include the step of creating the aluminum metal matrix composite material by providing the flowable aluminum material as an aluminum powder with the graphene and combining the aluminum and graphene. The step of processing the combination to create the aluminum metal matrix material can further include a sintering operation. The step of orienting the flattened sheets of graphene can further include processing into a single layer during a deformation process such as without limitation an extrusion or rolling process.

Other steps include the step of creating the aluminum metal matrix material further include combining the flowable aluminum with an alloying element not limited to AlSi10Mg. The thermal process further includes thixoforming, semi-solid forming, etc. the material.

The step of processing the combination to create the aluminum metal matrix composite material incorporating the graphene further including agitating the graphene in a pot containing the molten aluminum material. Finally, the step of orienting the flattened sheets of graphene further including solidifying the agitated combination of graphene and aluminum metal matrix composite.

Having described my invention, other and additional preferred embodiments will become apparent to those skilled in the art to which it pertains, and without deviating from the scope of the appended claims. This can include blending or impregnating graphene according to any loading percentage by volume relative to the aluminum material.

Additional embodiments can include providing the materials as atomized powders, this further envisioning agitating the few layer graphene in a molten pot containing a molten aluminum alloy, following solidification of which any suitable post processing or cold working operation is performed to create the desired AL MMC material with orientated graphene in order to provide enhanced conductivity.

The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A process for producing a graphene reinforced aluminum metal matrix composite material, comprising the steps of:
providing a flowable aluminum material;
providing a graphene material including any of a few layer graphene, multi-layer graphene or a graphene powder;
mixing the aluminum and graphene materials in order to disperse the graphene within the aluminum;
processing the mixed aluminum and graphene materials to create the composite article, including orienting the graphene along grain boundaries of the aluminum to enhance conductivity.

2. The process of claim 1, further comprising the step of providing the flowable aluminum material as an aluminum powder.

3. The process of claim 1, further comprising the step of milling the mixture of aluminum and graphene materials to a reduced diameter.

4. The process of claim 3, said step of processing the mixture of the aluminum and graphene materials further comprising a sintering operation.

5. The process of claim 4, said step of orienting the graphene provided as a few layer graphene or multi-layer graphene further comprising flattening the layers of the graphene into a single layer.

6. The process of claim 2, said step of providing the aluminum material as an aluminum powder further comprising combining the aluminum powder with an alloying element not limited to AlSi10Mg.

7. The process of claim 4, said step of sintering further comprising thixoforming the mixture of material.

8. The process of claim 1, further comprising a spot welding operation performed on the material.

9. The process of claim 1, said step of processing the combination to create the composite material incorporating the graphene further comprising agitating the graphene in a pot containing the molten aluminum material.

10. The process of claim 1, said step of processing and orienting the aluminum and graphene further comprising agitating the mixture.

11. A current carrying article providing high conductive properties, comprising:
a body of an aluminum metal matrix composite combined with multiple flattened graphene sheets oriented into a single layer of graphene in order to achieve enhanced electrical conductivity.

12. The current carrying component of claim 11, said body further comprising a busbar shaped article.
